(19) United States
(12) Patent Application Publication
(10) Pub. No.: US 2008/0065348 A1
(43) Pub. Date: Mar. 13, 2008

(54) DUCT GEOMETRY MEASUREMENT TOOL

(76) Inventor: Joseph F. Dowd, Bensalem, PA (US)

Correspondence Address: SYNNESTVEDT & LECHNER, LLP, 1101 MARKET STREET, 26TH FLOOR, PHILADELPHIA, PA, 19107-2950, US

(21) Appl. No.: 11/853,307

(22) Filed: Sep. 11, 2007

Related U.S. Application Data
(60) Provisional application No. 60/825,191, filed on Sep. 11, 2006.

(51) Int. Cl. G01B 7/02

(52) U.S. Cl. 702/155; 702/159

(57) ABSTRACT

A measurement tool for use in creating a customized duct segment for connecting existing adjacent HVAC ducts. The tool includes a handheld unit and a flag, each of which is configured for mounting to a respective duct. A measuring unit, such as a laser rangefinder, of the tool is capable of measuring a linear distance between the unit and the flag, and thus between reference points on the HVAC ducts, such as corners, to which the handheld unit and flag are mounted. The tool is configured to measure and store in its memory multiple distance measurements between multiple reference points. A method of using the tool involves gathering enough measurements between enough reference points, such as corners, that the required configuration for the customized duct segment can be determined, e.g. by CAD/CAM equipment. The tool may include a data port for transmitting gathered data for CAD/CAM purposes.

### CROSS-REFERENCE TO RELATED APPLICATION

This application claims the benefit under 35 U.S.C. §119(e) of U.S. Application No. 60/825,191, filed Sep. 11, 2006, the entire disclosure of which is hereby incorporated herein by reference.

### FIELD OF THE INVENTION

The present invention relates generally to the field of heating, ventilation and air conditioning (HVAC), and more particularly to a duct geometry measurement tool for use in creating a custom-made, geometrically-correct segment of sheet metal ductwork for connecting adjacent, spatially-separated HVAC ducts.

### DISCUSSION OF RELATED ART

Sheet metal ductwork is commonly used in HVAC applications in residential and commercial buildings as a conduit for heating, cooling and ventilation air. Although unusually-sized custom ducts may be found in the field, the vast majority of such ductwork is rectangular in cross-sectional shape. Such ducts usually have one of a variety of industry-standard, nominal cross-sectional dimensions, e.g. 10×16 inches, 10×12 inches, etc. Standard-sized ducts are used for the majority of most installations.

Due to the unique configurations of various buildings and locations in which ductwork is to be provided, the various combinations of dimensions of a single duct and of dimensions of adjacent ducts to be joined, sheet metal workers must often supply a unique, custom-made segment of sheet metal ductwork for connecting adjacent, spatially-separated sheet metal ducts. For example, such a customized segment may be required when two identically sized ducts are offset from one another along their longitudinal axes, when two differently sized ducts are aligned but need to be joined, and when two differently sized ducts are misaligned and need to be joined, etc. The required duct geometry is often complex and difficult to ascertain correctly.

A sheet metal worker in the field typically uses conventional measuring tools, such as a retractable measuring tape, to measure cross-sectional duct sizes, lateral offset distances, and distances between the ends of the ducts. FIGS. 1-3 show for illustrative purposes two exemplary adjacent, spatially-separated, differently sized ducts A, B that are laterally offset from one another, i.e., not aligned along their respective axes. The sheet metal worker seeks to supply a segment of ductwork having a unique duct geometry customized for connecting ducts A and B.

A common technique for creating such a ductwork segment involves taking dimensional, offset and spatial separation measurements along substantially perpendicular directions, e.g. along X, Y and Z directions in an XYZ coordinate system. More specifically, a common technique involves using the measuring tape to measure duct sizes/dimensions, i.e., cross-sectional lengths and widths of each duct, L_{A}, W_{A}, L_{B}, W_{B}, as best shown in FIG. 2. It has been found that these measurements can be regularly taken reliably and with a sufficiently high degree of accuracy.

The common technique further includes using the measuring tape to measure duct offsets, i.e. distances between sides of the adjacent ducts. This typically involves identifying a reference surface on each duct A, B, and then measuring the distance between the reference surfaces. This is often difficult, particularly when the ducts are separated by relatively large distances, e.g. 3 feet or more. To increase the accuracy of the measurements, a straight-edged member, such as a length of 2×4 lumber, a length of angle iron, etc., is laid against a first one of the reference surfaces so that a portion of the straight-edged member extends substantially parallel to the other of the reference surfaces. The sheet metal worker then uses the measuring tape to measure an offset distance, e.g. along a perpendicular line, between the member and the reference surface.

For example, as shown in FIG. 3, a straight-edged member 6 may be laid against a first reference surface 3 of duct A, and the measuring tape may be used to measure distance z₁ between the member 6 and a reference surface 5 of duct B. Knowing this distance and the widths W_{A}, W_{B} of ducts A and B provides information about the size and shape of the required ductwork segment. Additional measurements z₂, z₃ may be taken between other reference surfaces 7, 9 to corroborate the dimensional information. All of these dimensions are in a single direction, e.g. along the Z axis. This provides offset dimension information in the Z direction. Additional measurements Y₁, X₁, X₂, X₃, may be taken in perpendicular directions, e.g. along the X and Y directions to provide offset information in the X and Y directions.

Notes of these dimensions are then communicated, usually verbally or by hand sketch, to a sheet metal fabrication shop that may use manual techniques and/or CAD/CAM equipment to create a customized segment of ductwork that precisely matches the dimensions provided. Such CAD/CAM equipment may include commercially available computer aided design software, such as SOLIDWORKS® software distributed and/or sold by Solidworks Corporation of Concord, Mass., USA or AUTOCAD® software distributed and/or sold by Autodesk, Inc. of San Rafael, Calif., USA, and commercial available computer aided manufacturing equipment, such as a commercially available CNC plasma cutter machine. Such software is capable of accepting duct dimension and duct offset (spatial relationship) dimension information, and of creating instructions for the CAM equipment, e.g. in the form of digital data, for manufacturing the customized segment of ductwork.

It will be appreciated that a second worker is often needed to take such measurements in the field, e.g. to position and hold the straight-edged member, and that it is difficult to obtain such measurements with a high level of accuracy for a variety of reasons. These reasons include the need for the proper positioning of the straight edged member, the need for proper positioning of the measuring tape in a perpendicular orientation when measuring distances, and the exaggeration of errors due to the position of the straight-edged member and/or dimensional and/or shape irregularities in the reference duct when the gaps between the ducts are large, e.g. when distances may exceed a readily available straight-edged member.

As a result of these and other difficulties, the measurements taken in the field are often inaccurate, and it has been found that inaccuracies resulting in gaps between the duct A, B and the customized ductwork segment as small as 0.25 inches, and even as small as 0.125 inches, are unacceptable. The customized ductwork segment usually cannot be adjusted for a satisfactory fit. As a result, improperly sized customized ductwork segments are often discarded and/or destroyed, resulting in waste of sheet metal worker time, excessive material and fabrication costs, and overall project delays, all of which are expensive.

What is needed is a duct geometry measurement tool for taking accurate measurements between adjacent ducts in the field, and for use in creating a customized, geometrically correct segment of sheet metal or other ductwork for connecting adjacent, spatially separated ducts.

### SUMMARY OF THE INVENTION

An embodiment of the present invention provides a computerized duct geometry measurement tool that includes a handheld unit configured to take measurements in the field and record those measurements in electronic form. The handheld unit may include a hands-free measuring unit, such as a laser rangefinder, capable of measuring a distance between two points without the need for manual assistance from a human worker. The handheld unit preferably includes a display screen and one or more buttons that are operable by a worker to identify to the handheld unit a pair of ducts' points between which the distance measurement has been or is about to be taken. The measuring unit is preferably mounted on a turret that is removably mounted on a handle member of the handheld unit. The measuring unit may be adjustably mounted to the turret to allow rotational movement about at least two orthogonal axes. Optionally, the tool is configured to measure and/or record angular measurements. The turret and/or handle member is configured for mounting on a duct, e.g. to include a channel configured to receive a right-angle corner portion of a duct.

The duct geometry measurement tool may also include a flag that is configured, e.g. with a channel configured to receive a right-angle portion of a duct, for mounting on another duct. The flag is configured to cooperate with the measuring unit to provide an accurate measurement between the ducts, e.g. between the corners of the ducts. In one embodiment, the flag includes a visible guide that acts as a target for facilitating proper alignment of a laser emitting device on the handheld unit, to ensure that measurements are being taken between the corner points of the respective ducts.

Preferably, the duct geometry measurement tool is computerized, e.g. to include a customized PDA, and includes a microprocessor, memory and software and/or circuitry for gathering the measurement data collected and transmitting it in digital data form to an external device, such as a PC, CAD/CAM equipment, etc., e.g. via a USB or other conventional electronic data communications port. Preferably the software and/or circuitry is configured to perform calculations and format the measurement or calculated data in *.dxf or other data file format for export to the external device in a readily recognizable manner such that the measurement data obtained by the duct geometry measurement tool can be communicated to a human designer, or to CAD/CAM equipment for automatedly manufacturing parts in accordance with the measurements obtained. A battery-based power source may also be provided in the handle member 48.

Accordingly, the flag is configured to be mounted to a first duct in a first predetermined spatial relationship relative to a first reference point of the first duct, and the handheld unit is configured to be mounted to a second duct in a second predetermined spatial relationship to a second reference point of the second duct, and the hands-free distance measuring unit is operable to measure a distance between the first and second reference points as a function of the first and second predetermined relationships and the measured distance between the flag and the handheld unit. The tool may include a memory storing instructions executable by the microprocessor to store in the memory a distance between the first and second points/corners as a function of the first predetermined spatial relationship, the second predetermined spatial relationship, and a distance measurement taken by the distance measuring unit between the flag and the handheld unit.

Measurement in accordance with the present invention may include measuring a plurality of linear distances from one or more points, e.g. corners, of a first duct to one or more points, e.g. corners, of a second duct. Preferably, the points are arranged along perimeters of the distal ends of the ducts, e.g. at the corners for ducts having square or rectangular cross-sections, and elsewhere for ducts having round or other cross-sections. The distance measurements are then stored in a memory of the computerized tool, such that data corresponding to the stored distances and/or the points between which each measurement was taken can be transmitted via a communications port of the tool to a CAD/CAM device.

### BRIEF DESCRIPTION OF THE DRAWINGS

The present invention will now be described by way of example with reference to the following drawings in which:

FIG. 1 is a perspective view of exemplary spatially separated HVAC ducts according to the prior art;

FIGS. 2 and 3 are top and side views, respectively, of the ducts of FIG. 1;

FIG. 4 is a perspective view of an exemplary duct geometry measurement tool in accordance with the present invention, shown mounted on the ducts of FIG. 1;

FIG. 5 is a perspective view of the ducts of FIG. 1, showing schematically exemplary measurements taken in accordance with the present invention;

FIG. 6 is a perspective view of an exemplary customized ductwork segment for the ducts of FIG. 1;

FIGS. 7A-7D are perspective, top, front and side views of the handheld unit of the exemplary duct geometry measurement tool of FIG. 4;

FIG. 8 is a side view of the exemplary handheld unit of FIG. 7D, shown with the turret demounted from the handle;

FIGS. 9A-9E are perspective, top and left side and right side views of the flag of the exemplary duct geometry measurement tool of FIG. 4;

FIG. 10 is a perspective view of an alternative embodiment of a flag in accordance with the present invention;

FIG. 11 is a flow diagram illustrating an exemplary method of use of the duct geometry measurement tool of FIG. 4; and

FIG. 12 is a block diagram of the duct geometry measurement tool of FIG. 4.

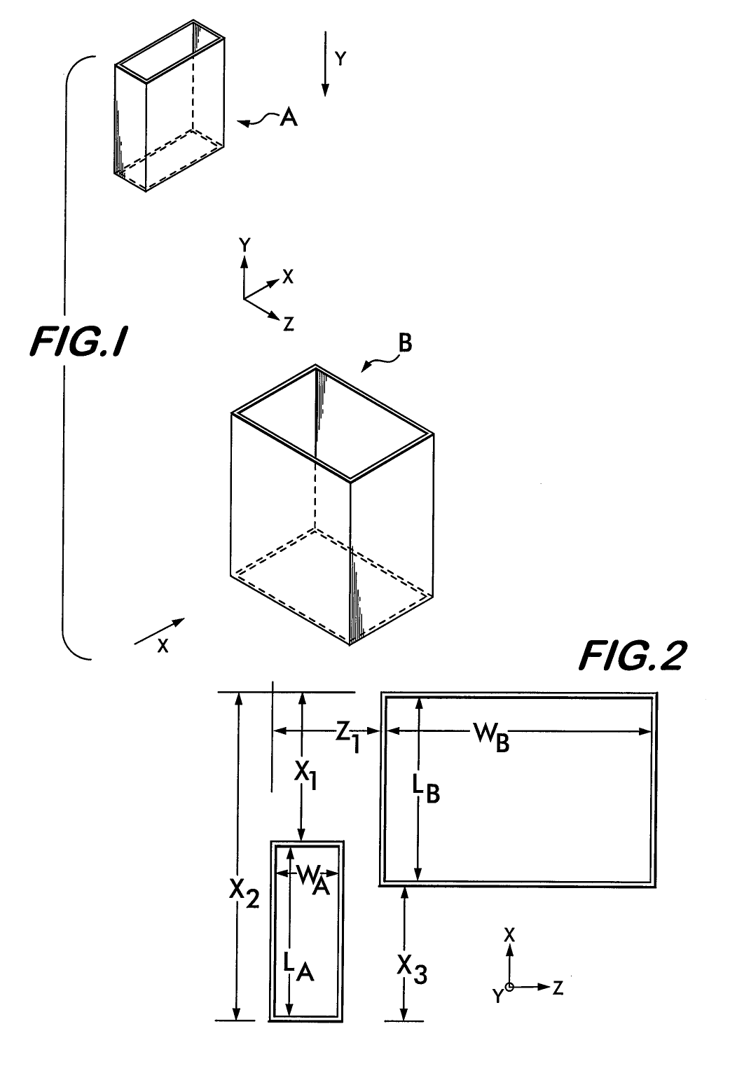

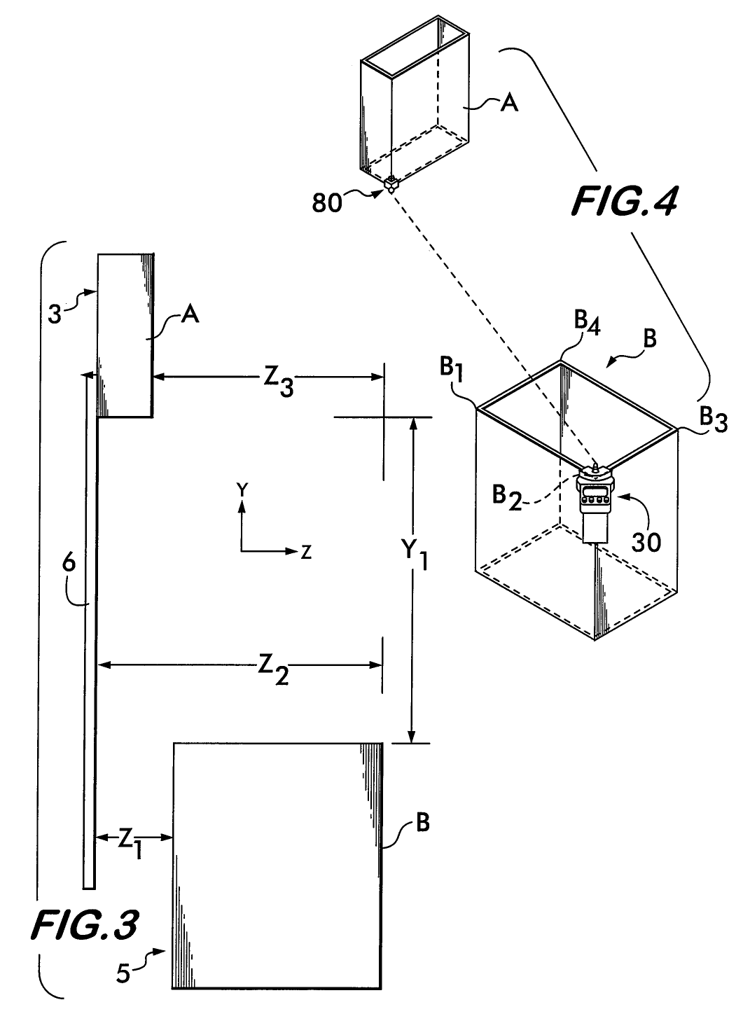

### DETAILED DESCRIPTION

The present invention provides a method for taking measurements between adjacent, spatially-separated HVAC/other ducts, a duct geometry measurement tool for taking measurements that define a customized segment of ductwork for joining adjacent ducts, and a method for constructing a customized ductwork segment using those measurements.

Referring now to FIG. 4, two exemplary ducts, A, B, are shown that are adjacent, spatially-separated, axially offset, and differently sized. An exemplary duct geometry measurement tool 30 is shown mounted on the ducts A, B. The tool 30 may be used to take measurements to be used to create a customized ductwork segment for joining ducts A and B.

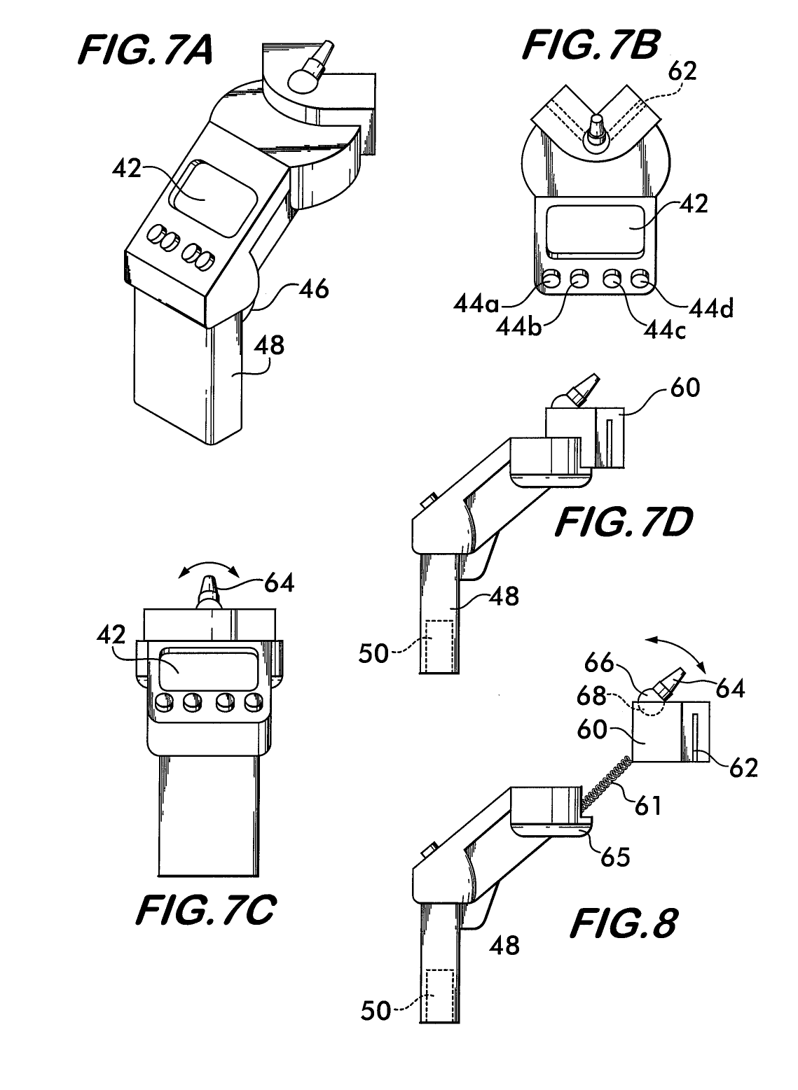

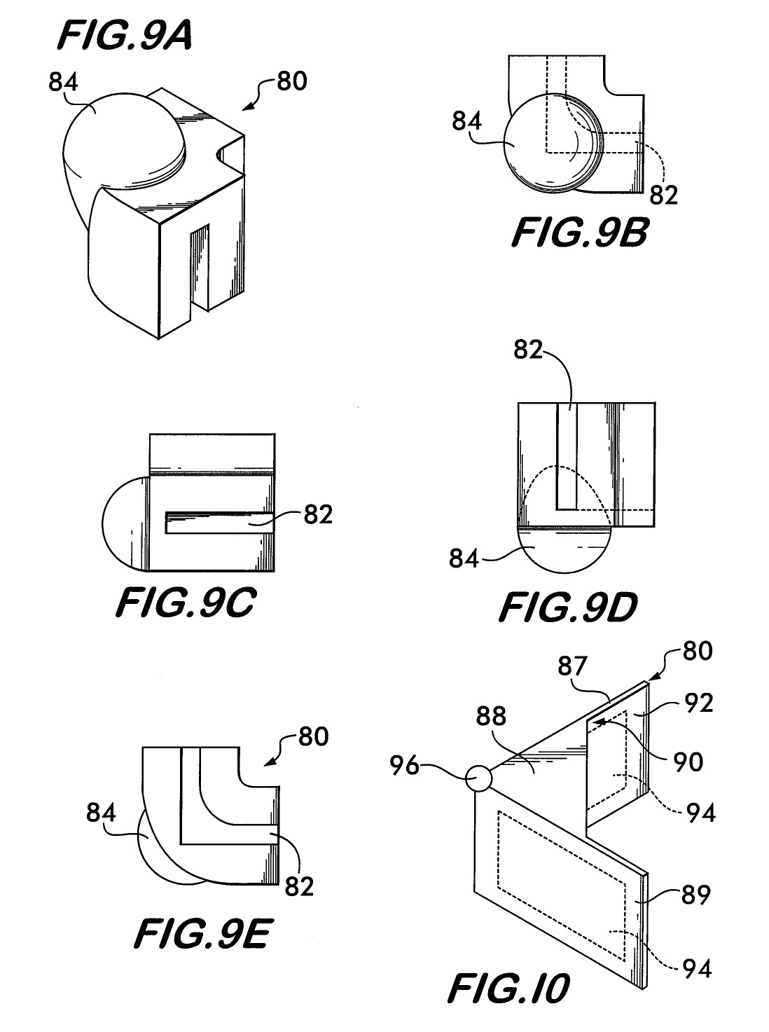

As shown in FIGS. 4, 7A-7D, 8 and 9A-9E, the exemplary duct geometry measurement tool 30 includes both a handheld unit 40 (FIGS. 7A-7D) and a flag 80 (FIGS. 9A-9E). The handheld unit 40 preferably includes a hands-free measuring unit capable of measuring a distance between two points without the need for manual assistance from a human worker throughout the action of taking the measurement. Any conventional hands-free measuring technology may be used for this purpose. For example, such conventional technology may include infrared, ultraviolet or ultrasound emitters, transmitters and/or receivers (collectively, “emitter”). Devices including such hands-free measuring technology are “hands-free” in that they require manual assistance only to initiate the taking of the measurement, e.g. pressing a button, and do not require manual assistance by a human worker in the action of taking the measurement itself. Thus, measurements can be obtained by a single human worker, and accurately.

In a preferred embodiment, conventional laser rangefinder hands-free measuring technology of a type presently incorporated into commercially available distance measuring products, such as the FatMax® TruLaser Distance Measurer manufactured and/or distributed by The Stanley Works of New Britain, Conn. and/or Leica Geosystems, which allows for measurement of distance traveled by laser light emitted from the device to a surface struck by the laser light. An exemplary laser-based distance measurement to a surface generally involves measuring the time it takes for a laser beam to travel from the laser rangefinder to the surface, and then reflect back to the laser rangefinder. Knowing this time duration and the speed of light in air, the distance to the surface can be calculated by multiplying the speed of light by half of the time duration. Similar technology is disclosed in U.S. Pat. Nos. 5,815,251, 5,892,576, 5,949,531, 6,307,636, the entire disclosures of which are hereby incorporated herein by reference.

Referring again to FIGS. 7A-7D, the handheld unit 40 preferably further includes an LCD or other display screen 42 and one or more buttons 44a, 44b, 44c, 44d that are operable by the worker to identify to the handheld unit 40 duct dimensions and/or orientations, and which measurement has been or is about to be taken. The handheld unit 40 preferably further includes a pivotable trigger 46 or button manually actuatable to initiate taking of a distance measurement, and an elongated handle grip 48. An electronic data communications port 50 is preferably provided on the handle 48 to receive a compact flash (CF), secure digital (SD), memory stick, or other memory card, a USB memory key, or a USB or similar data communications cable, so that measurement data gathered by the handheld unit can be transmitted to an external device, such as a PC or CAD/CAM equipment.

The emitter or other operative portion of a hands-free measuring device is preferably mounted on a turret 60 of the handheld unit 40. In one embodiment, the turret 60 is removably mounted to the handle member 48, as best shown in FIGS. 7D and 8. The turret 60 is operably connected, e.g. by a wire lead 61, to the microprocessor, memory, electronic circuitry and/or display device 42 of the handheld unit 40. The turret 60 and a base 65 of the handle member 48 may have complementary interfitting structures, e.g. ribs and grooves, pins and sockets, etc., allowing for selective coupling and decoupling of the turret to the base 60 via a friction fit. The turret 60 defines a channel 62 configured to receive a portion of the duct, e.g. a right angle corner portion, such as corner B2. The removability of the turret 60 allows for placement of the turret 60 at one location (e.g., on a duct) and viewing of the display screen 42, operation of the buttons 44a-44d, etc. at a nearby, more convenient location, to permit taking of measurements from hard-to-reach locations, etc.

Preferably, the measuring unit includes a laser emitting device 64 including conventional laser rangefinder technology for measurement of distances. Such technology is beyond the scope of the present invention, and thus is not discussed in detail here. The laser emitting device 64 is movably mounted to allow rotational movement about at least two orthogonal axes. For example, a laser emitting device 64 may be mounted on a ball 66 seated in a socket joint 68 of the turret 60 to allow for both vertical and horizontal movement of the laser emitting device 64 relative to the turret 60 and corner, e.g. B2, of the duct B. This allows the laser emitting device 64 (and thus the laser) to be adjustably moved into alignment with a corner or other target area of a duct while the turret 60 remains stationary on an adjacent duct.

In a certain embodiment, the turret 60 and/or laser emitting device 64 is specially configured to allow the tool 30 to record not only linear distance measurements, but also angular measurements, that are used to identify the spatial relationship between points on the adjacent ducts. For example, the turret 60 and/or laser emitting device 64 may be provided with a scale/dial and a pointer that indicates an angular position of the laser emitting device relative to the corner, duct, tool, etc. For example, the scale may be used to indicate that the emitter device is presently aimed at 37 degrees in a first plane, relative to a reference edge of a duct, and 63 degrees above the first plane, in a second plane normal to the first plane, e.g. to relate corners of the ducts in space, as discussed in greater detail below. This allows an operator to manually read the scale/dial and identify an angular position. Alternatively, the tool is configured with hardware, sensors, etc., such as transducers, that allow the tool to automatedly sense and record an angular position of the laser emitting device, etc.

Alternatively, an infrared or ultraviolet emitter, or an ultrasonic transmitter device may be provided instead of the laser emitting device 64.

The duct geometry measurement tool 30 may also include a flag 80 that is configured to cooperate with the measuring unit to obtain an accurate measurement between corners (or other points) of the ducts. As shown in FIGS. 9A-9E, the flag 80 is configured for mounting on another duct, e.g. at a right angle corner A2 of the duct A, as shown in FIG. 4. In certain embodiments, the flag 80 may include audio signal circuitry, a transmitter or receiver (e.g., for infrared or ultraviolet applications), etc. to cooperate with the components of the measuring unit in the handheld unit 40 to allow for accurate distance measurement therebetween. By way of example, the flag may include circuitry for producing an audible signal when laser light is detected at a photoreceptor of the flag 80, i.e. at a target area on the flag, that represents alignment with the corner/reference point and thus indicates that the desired measurement is ready to be obtained.

In a preferred embodiment, the flag 80 does not include any such circuitry or other active components, and is formed as a unitary, injection-molded plastic body to include a channel 82 configured to receive a right-angle portion of the other duct A. In this embodiment, the flag merely acts as a reflector and/or visual target for aligning the laser emitting device 64, etc. of the handheld unit 40 with the corner A2, etc. of the other duct so that an accurate distance measurement may be obtained between corners of ducts A and B. The flag 80 may include a visible guide that acts as a target for aligning a laser emitting device on the handheld unit, e.g. a reflector, a white dot illuminatable by the laser, a bullseye image, a hole, etc. The exemplary embodiment shown in FIGS. 9A-9E shows a reflective dot that will be “illuminated” with incident laser light when the laser beam is aligned with it, and thus will provide a visual indication that the laser device is aligned with the corner or other suitable reference point of the adjacent duct.

In accordance with the present invention, the measuring unit of the duct geometry measurement tool is constructed and/or calibrated so that taking of a distance measurement with the duct geometry measurement tool accurately reflects the measurement of distance between the precise edges/corners (“reference points”) of the respective ducts positioned within the groove of the turret 60 and/or flag 80, etc. This calibration can be performed in a straightforward manner as a function of the construction of the handheld unit 40 and the flag 80. Preferably, only the calibrated/calculated distance value is displayed and/or stored by the tool 30.

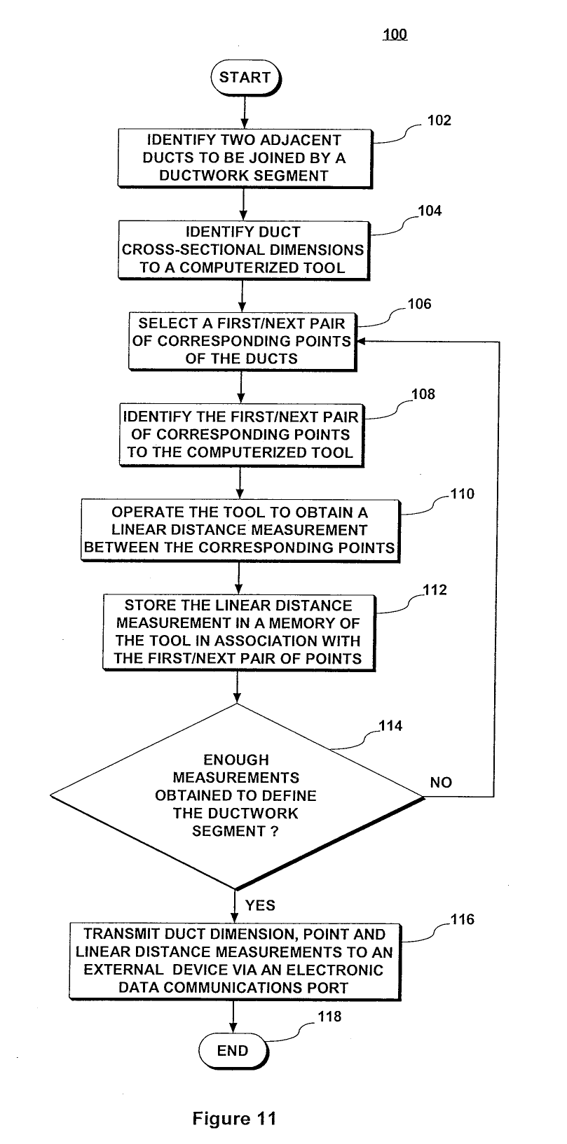

FIG. 10 shows an alternative embodiment of the flag 80 that includes three sides 87, 88, 89 positioned at right angles to one another, and including magnets 94 adjacent their inner surfaces 92 to retain the flag against an outer surface of a corner of a metallic duct. This flag 80 also includes a visual alignment fiducial in the form of a translucent plastic nub 96 positioned at the corner that disperses laser light when a laser passes therethrough.

A method of taking measurements in accordance with the present invention includes measuring a plurality of linear distances from one or more reference points, e.g. corners (B1, B2, B3, B4), of a first duct (e.g., B) to one or more reference points, e.g. corners (A1, A2, A3, A4), of a second duct (e.g., A). Preferably the reference points are arranged along perimeters of the distal ends of the ducts, e.g. at the corners for ducts having square or rectangular cross-sections, and 90 degree or other intervals for ducts having round cross-sections, and at other locations for ducts having other cross-sections.

More specifically, an exemplary method involves first measuring the length and width of the two ducts A, B to be joined, e.g., using a conventional measuring tape. These measurements are then entered via an interface provided via the display screen 42 of the handheld unit 40. For example, button 44a may be used to select menu options displayed on the screen indicating a first duct's length, a first duct's width, and measurements in inch units. The measurements may be entered into appropriate fields presented by via the display screen 42 by using a touchscreen keypad of a type used in conventional PDA devices distributed by Palm, Hewlett Packard, etc. Any suitable conventional technology may be used for this purpose. Alternatively, the tool may be used to make and record such measurements in a manner similar to that disclosed below.

The duct geometry measurement tool 30 may then be used to obtain measurements by placing the turret 60 on a first corner B2 of a first duct B and the flag on a second corner A2 of a second duct A, as shown in FIG. 4. The trigger 46 may then be pulled a first time to cause emission of a continuous beam of laser light from the laser emitting device 46. The laser emitting device 64 may then be manually pivoted relative to the turret 60 until the emitted laser beam strikes the flag 80 in the desired manner, e.g. to illuminate nub 96, reflector 84, to pass through a hole in the flag, to be centered within a bullseye on the flag, to strike a white target dot on the flag, etc. to signify that the laser is properly aligned between corners A2 and B2.

The trigger 46 may then be pulled a second time, a button may be pressed, etc. to initiate taking and/or recording of a distance measurement between the laser emitting device 46 on the handheld unit 40 and the flag 80, which in turn results in output of a corner-to-corner measurement (through actual distance, calibration and/or calculation) that represents the distance between corner A2 and corner B2. In this example, button 44b is usable to navigate a visual interface provided via display screen 42 to select a corner of the first duct, and button 44c is usable to select a corner of the second duct that represents the corners between which the measurements have been taken. Button 44d is selectable to store the measure distance in association with the corners selected via buttons 44b and 44c. It will be readily understood that this description of the interface is illustrative only, and that any suitable interface may be provided for collecting and storing the measured distance data. For example, touch-sensitive, user-selectable buttons may be provided via a touch sensitive display screen 42, instead of the physical buttons described above.

In certain embodiments, angular measurements may be made and recorded, either manually or automatedly, at this time, depending upon the configuration of the device.

In accordance with the present invention, additional distance measurements are taken between additional points, e.g. corners. As best shown in FIG. 4, the distances are primarily corner-to-corner (or point to point) linear distances taken along irregularly oriented intersecting lines, and are not distance measurements taken along orthogonal axes as is conventional. For example, the flag 80 may be moved to corner A1, the distance between B2 and A1 may be measure and stored in association with the corners, and then the method may be repeated for another corner, e.g. corner A3.

In accordance with the present invention, there are various combinations of measurements that may be taken to provide the information required to manufacture a customized ductwork segment.

In one embodiment, only linear distance measurements are measured and stored by the tool. Accordingly, the tool need not be configured to provide for angular measurements. Measuring three linear distances from a single point, e.g. B2, has been found to uniquely identify the spatial relationship between the point B2 and the duct A. However, due to dimensional variations in the ducts themselves, it is preferred to take linear distance measurements to all four corners (A1, A2, A3, and A4) from a first reference corner (B2), and for all four reference corners (B1, B2, B3, B4). This is believed to give the highest level of dimensional accuracy, although taking of fewer measurements may be found satisfactory. For example, taking only duct dimension measurements, and four distance measurements between corresponding corners (e.g., A1B1, A2B2, A3B3 and A4B4) may provide a sufficient level of accuracy in very few measurement steps. In such an embodiment, the tool provides linear distance measurement information, and optionally information identifying points between which the points were taken, to external CAD, CAM or similar conventional software, and such conventional software is used to create a three-dimensional model of the customized ductwork that is used to create a two-dimensional model of a ductwork blank to be cut by a plasma cutter, etc., and optionally instructions to be used by a plasma cutter to manufacture the ductwork blank. By way of example, commercially available software such as ProfileMaster 2000, Vulcan 2, Design CAD, Plate ‘n’ Sheet or AutoCAD software may be used for one or more of these purposes. Accordingly, data from the tool can be used in a straightforward fashion to create instructions for a plasma cutter, etc.

In another embodiment, both linear distance measurements and angular measurements are measured and/or stored by the tool. In one such embodiment, a linear distance measurement and an angular measurement is recorded for each pair of corresponding corners, so that one corner, e.g. B1, can be related in space to another corner, e.g. A1, using polar coordinate type notation. For example, the measurements may be interpreted to define the position of B1 as 60 degrees above a horizontal reference plane including A1, and 30 degrees to the right of a vertical reference plane including A1, at a distance of 40 inches from an origin point. In such an embodiment, the tool may provide linear distance and/or angular measurement information to external software, etc. to design a two-dimensional ductwork blank that can be cut from sheet material by a plasma cutter, etc. Accordingly, data from the tool can be used in a straightforward fashion to create instructions for a plasma cutter, etc.

In another embodiment in which both linear distance measurements and angular measurements are measured and/or stored by the tool, either the tool or external software performs trigonometric or other mathematical calculations to solve for offset linear dimensions in the X, Y and Z directions. More specifically, sine, cosine, tangent and/or other trigonometric functions may be used to mathematically calculate, as a function of linear distance and angular measurements taken by the tool, linear offset dimensions between corresponding sides or ends of the adjacent ducts. These linear offset dimensions correspond to the dimensions that are typically measured using angle iron, 2×4 lumber, etc. Accordingly, conventional methodology of relating duct dimension and duct offset information to a human designer/engineer may be used, and the ductwork may be designed and manufactured in a conventional fashion, but with measurements taken by the tool that are much more precise than those taken using the conventional methods described above. Alternatively, the tool may be configured to arrange duct dimension and offset information in a formatted electronic data file that can be directly imported into commercially available ductwork design software, such as ProfileMaster2000, for designing ducts in an automated fashion.

Various other techniques may be used to gather, manipulate and output linear distance and/or angular measurement information so that the appropriate ductwork segment may be designed and/or manufactured, in an automated or manual fashion, as will be appreciated by those skilled in the art. By way of example, software may be provided on a general purpose PC, etc. to accept such measurements from the tool and prepare data for import into a commercially available software package, or the tool may perform processing or formatting functions to prepare data for communication to a human designer, or to an external, commercially available software package, etc.

As referred to above, the duct geometry measurement tool 30 preferably includes software, firmware and/or circuitry for gathering the measurement data collected and transmitting it in digital data form to an external device, such as a PC, CAD/CAM equipment, etc., e.g. via a USB or other conventional electronic data communications port. Preferably the software and/or circuitry is configured to format the corner identification and dimensional data in *.dxf or other conventional data file formats for export to the external device in a readily recognizable manner such that the measurement data obtained by the tool 30 can be communicated to CAD/CAM equipment to automatedly manufacture parts and/or a duct in accordance with the measurements obtained through use of the tool 30. The gathered data may be imported into a solid modeling program or other CAD/CAM software that can accept such corner identification and dimensional data and provide instructions to a plasma cutter, etc. in a straightforward manner, such that the required customized ductwork segment, e.g. as shown in FIG. 6, can be fabricated in a conventional manner, e.g. using a plasma cutter and conventional design and fabrication techniques. For example, ProfileMaster 2000 ductwork design software may be used to design a duct and/or create instructions for a plasma cutter as a function of measurements taken by the tool, bend line specifications, slip side and drive side specifications, flange specifications, etc. as known in the art.

Alternatively, the tool 30 is capable of transmitting electronic data for creating a printout on paper showing an image of the duct and/or dimensional information of a type that can be related to a ductwork fabricator for manual fabrication of the customized ductwork segment and/or manual entry of such data into a CAD/CAM system for manufacture of the customized ductwork segment.

FIG. 11 is a flow diagram 100 of a method of measuring duct geometry and using the tool 30, in accordance with the present invention. As shown in FIG. 11, the method begins by identifying two adjacent ducts to be joined by a ductwork segment, as shown at step 102. For example, this involves observing in the field ducts A and B of FIG. 1.

The cross-sectional dimension(s) of each duct is then identified to the tool, as shown at step 104. For example, this may involve measuring each duct with a conventional retractable measuring tape, and providing the measurements to the tool 30 via its interface, e.g. by tapping displayed numbers on the tool's touchscreen 42. The tool 30 could also be used to take these measurements in a manner similar to that described below. It should be noted that length and width dimensions may be provided to imply a rectangular duct, a diameter may be provided to imply a circular duct, etc. Alternatively, a cross-sectional shape may be specified by the operator of the tool, e.g. by selecting a shape from a menu of shapes displayed via the tool's touchscreen 42.

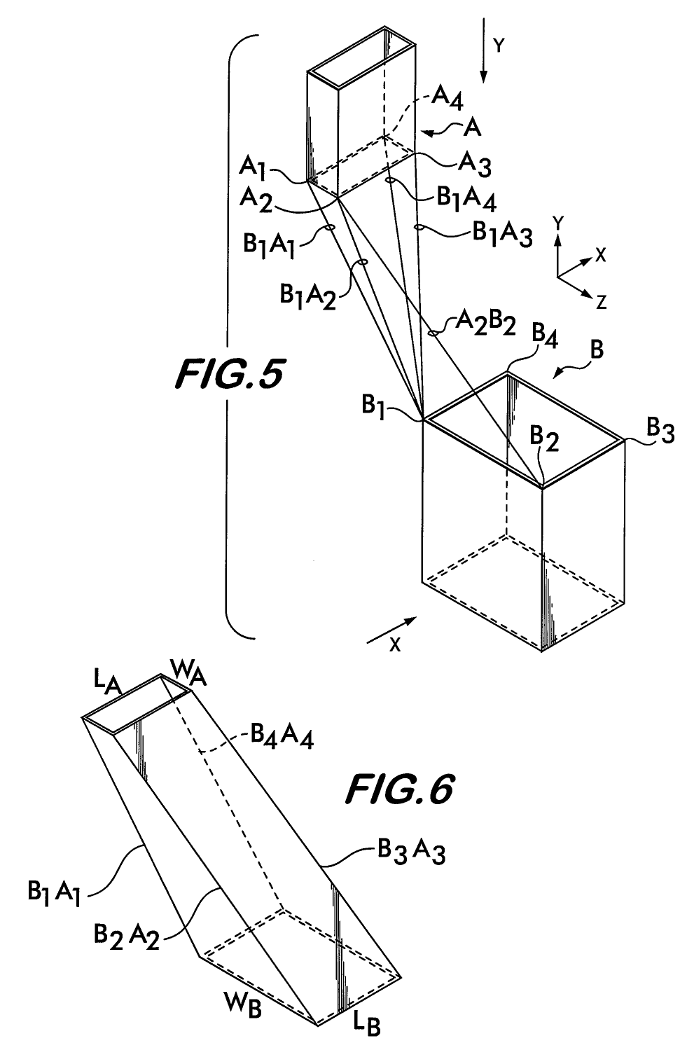

The laser, etc. measurement mechanism of the tool 30 is then used to obtain a plurality of measurements, each measurement being between a point on the first duct and a point on the second duct. In this example, which relates to the exemplary rectangular cross-section ducts of FIG. 1, a first pair of corresponding points of the ducts is first identified to the tool 106. For example, point A1 corresponds to point B1, A2 to B2, A3 to B3, and A4 to B4 in that the corresponding corners are to be connected by the ductwork segment to provide a proper, enclosed duct from duct A to duct B. For example, the user may select corresponding points A2 and B2 shown in FIG. 5.

The operator of the tool then identifies the select pair of corresponding points to the tool 30, as shown at step 108. For example, the device's touchscreen 42 may display two ducts representing ducts A and B, and each corner may be identified by tapping the touchscreen in locations corresponding to points A2 and B2. Alternatively, a button may be pressed that corresponds to each corner, a menu option may be selected from a menu displayed on the touchscreen, a button may be pressed to toggle through each corner, etc.

The tool 30 is the operated to obtain a linear distance measurement between the corresponding points A2, B2, as shown at step 110. Such operation involves mounting the flag 80 at one of the selected points, e.g. at corner A2, and the tool 30 (or at least turret 60) at the other of the selected points, e.g. at corner B2, as shown in FIG. 4. After the flag 80 and turret 60 are properly positioned, the laser or other hands-free measuring device is operated to take a measurement between the flag and turret 60, which represents the distance between corners A2 and B2. In this example, taking the measurement involves operating the trigger 46 to cause continuous emission of laser light, manually manipulating the laser emitting device 64 until the beam strikes the flag 80 or a desired portion of the flag 80, such as the nub 96, and then pressing a button, etc. to initiate capturing of the measurement by the tool.

The tool, with or without confirmation by the operator, stores the linear distance measurement taken in the tool's memory in association with the pair of points. Accordingly, for example, the tool may record data indicating that the distance between corner A2 of duct A and corner B2 of duct B is 43.15 inches.

The tool then determines whether enough measurements have been taken to define with certainty the ductwork segment, as shown at step 114. If not, the user is prompted, e.g. via a message displayed via the tool's touchscreen 42, to take a next measurement between another pair of points, and the process repeats. The device may be preprogrammed with combinations of measurements that are considered enough to define with certainty the ductwork segment. For example, four measurements taken from a single corner of one duct (e.g. B1) to four different corners (e.g. A1, A2, A3, A4) may be insufficient to define with certainty the required geometry of the required ductwork segment. Alternatively, four measurements taken between respective corners, i.e. from A1 to B1, from A2 to B2, from A3 to B3 and from A4 to B4, may be considered sufficient to define with certainty the required geometry of the required ductwork segment (when coupled with the duct shape and dimension information). Sixteen measurements (between each pair of all 8 corners) are sufficient to define with certainty the required geometry of the required ductwork segment, but likely include redundant information.

If it is determined in step 114 that enough measurements have been taken and stored, then the device preferably displays an indication, such as text or an image, via the display device to notify the operator of the device. The operator may then transmit duct dimension information and distance measurement information, including an identification of points between which the dimensions were taken, from the memory of the tool 30 to an external device via an electronic data communications port, as shown at step 116. For example, this may be initiated by selection of a menu option, pressing of a button, etc. The data may be transmitted to a removable memory card, or via a USB, wireless or other port, etc. The data may be transmitted to a printer for printing, to a PC, to a plasma cutter to be used in fabricating a duct, etc. Preferably, the data is exported as formatted data in a conventional data file format, such as *.dxf, so that it can be imported into a CAD/CAM software program running on an external computer.

From the perspective of the tool 30, a method of operation relating to sizing, designing and manufacturing of a customized ductwork segment involves receiving dimensional information relating to duct sizes and/or shapes, e.g., as measured with the device or as provided by an operator of the device via the touchscreen or other interface. The method further includes receiving information identifying pairs of points, such as corners, along the ducts, e.g., as measured with the device or as provided by an operator of the device via the touchscreen or other interface. The method further includes taking a respective distance measurement between each pair of points, e.g. by operation of the hands-free measuring unit of the device. For example, this may include initiating capture of a distance measured by a laser rangefinder, using substantially conventional laser rangefinder measurement technology, after an operator presses a button or otherwise identifies that the laser rangefinder is properly aligned between corner or other reference points. The method also includes storing distance measurement information in association with an identification of the pair of points between which the distance was measured. This may be done automatically responsive to capturing of a measurement, or by manual initiation, e.g. by sensing pressing of a button, etc. Accordingly the device stores not only a recorded distance, but also information identifying points between which the distance was measured. For example, such points may be identified with reference to an image of two or more ducts displayed via a display screen of the device, e.g. points A2 and B2 as shown on the display screen. Further, the method includes transmitting the point and distance information, e.g. in digital data form, to a CAD/CAM device, such as a PC running CAD and/or CAM software, CAM machinery such as a plasma cutter, etc.

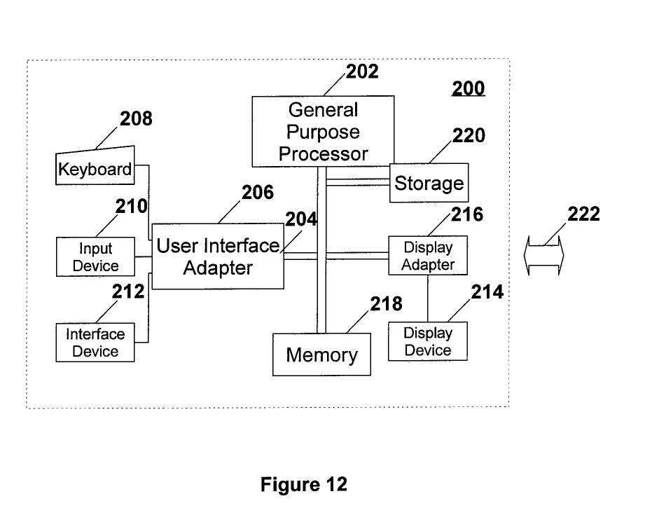

FIG. 12 is a block diagram of a computerized duct geometry measurement tool 200 in accordance with the present invention. The tool 200, which may include conventional computer and/other hardware storing and executing specially configured computer software for carrying out a method and for performing the functionality described above in accordance with the present invention.

Accordingly, the tool/computerized system 200 of FIG. 12 includes a general purpose microprocessor (CPU) 202 and a bus 204 employed to connect and enable communication between the microprocessor 202 and the components of the server 200 in accordance with known techniques. The server 200 typically includes a user interface adapter 206, which connects the microprocessor 202 via the bus 204 to one or more user interface/input devices, such as a keyboard 208 (which may include buttons 441-44d), mouse/other input device 210 and/or other interface devices 212, which can be any user interface device, such as a touch sensitive display screen 42, digitized entry pad, etc. The bus 204 also connects a display device 214, such as an LCD screen or monitor or a touchscreen monitor display screen 42, to the microprocessor 202 via a display adapter 216. The bus 204 also connects the microprocessor 202 to memory 218 and long-term storage 220 (collectively, “memory”) which can include a hard drive, diskette drive, tape drive, etc.

The tool 200 may communicate with other computers or networks of computers, for example via a communications an electronic data communications channel, port network card or modem 222. The tool 200 may be associated with other computers in a local area network (LAN) or a wide area network (WAN), or as a peripheral device. Such configurations, as well as the appropriate communications hardware and software, are known in the art.

The tool's software and/or other operating instructions are specially configured in accordance with the present invention. Accordingly, as shown in FIG. 12, the tool 200 includes various software-implemented components configured to implement one or more aspects described above.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A duct geometry measurement tool comprising:
a flag configured to be mounted to a first duct in a first predetermined spatial relationship to a first reference point of said first duct; and
a handheld unit configured to be mounted to a second duct in a second predetermined spatial relationship to a second reference point of said second duct, said handheld unit comprising:
a distance measuring unit operable to measure a linear distance between said first and second reference points as a function of positions of said flag, said handheld unit, and said first and second predetermined spatial relationships; and
a memory operably connected to said distance measuring unit for storing measured distances.

2. The duct geometry measurement tool of claim 1, wherein said flag defines a channel configured to receive a first portion of said first duct that includes said first reference point.

3. The duct geometry measurement tool of claim 2, wherein said channel is configured to receive a corner portion of said first duct, said first duct being substantially rectangular in cross-section.

4. The duct geometry measurement tool of claim 1, wherein said flag comprises substantially planar first, second and third sides positioned orthogonally to one another, said flag comprising at least one magnet for mounting the flag to a metallic duct.

5. The duct geometry measurement tool of claim 1, wherein said handheld unit defines a channel configured to receive a second portion of said second duct that includes said second reference point.

6. The duct geometry measurement tool of claim 5, wherein said channel is configured to receive a corner portion of said second duct, said second duct being substantially rectangular in cross-section.

7. The duct geometry measurement tool of claim 1, wherein said distance measuring unit comprises a laser rangefinder.

8. The duct geometry measurement tool of claim 1, wherein said handheld unit comprises:
a handle grip having a base; and
a turret releasably mounted to said base, said turret defining a channel configured to receive said second portion of said second duct that includes said second reference point.

9. The duct geometry measurement tool of claim 8, wherein said distance measuring unit comprises a laser rangefinder, and wherein an emitting device of said laser rangefinder is mounted on said releasably mounted turret.

10. The duct geometry measurement tool of claim 9, wherein said emitting device is adjustably mounted to allow rotational movement about at least two orthogonal axes.

11. The duct geometry measurement tool of claim 10, wherein said emitting device is mounted on a ball seated in a socket defined by said turret.

12. The duct geometry measurement tool of claim 1, further comprising:
a data communications port operably connected to said memory to transmit data corresponding to said distance stored in said memory.

13. The duct geometry measurement tool of claim 12, wherein said memory is configured to store a plurality of different distance measurements between a plurality of different reference points, and wherein said data communications port is configured to transmit data corresponding to said plurality of different distance measurements stored in said memory.

14. A duct geometry measurement tool comprising:
a flag configured to be mounted to a first duct in a first predetermined spatial relationship to a first reference point of said first duct; and
a handheld unit comprising:
a handle grip supporting a base;
a turret mounted to said base, said turret being configured to be mounted to a second duct in a second predetermined spatial relationship to a second reference point of said second duct;
a distance measuring unit mounted to said turret, said distance measuring unit being operable to measure a distance between said first and second reference points as a function of a spatial relationship between said flag and said turret;
a memory operably connected to said distance measuring unit to store in said memory a plurality of measured distances, each of said plurality of measured distances being stored in said memory in relation to respective reference points of said first and second ducts between which each distance was measured; and
a data communications port operably connected to said memory to transmit data corresponding to said measured distances.

15. The duct geometry measurement tool of claim 14, wherein said turret is releasably mounted to said base.

16. The duct geometry measurement tool of claim 15, wherein said distance measuring unit comprises a laser rangefinder having a laser emitting device, said laser emitting device being adjustably mounted on said turret to permit alignment of said laser emitting device with said flag.

17. The duct geometry measurement tool of claim 14, further comprising;
a microprocessor operably connected to said memory;
a display device operably connected to said microprocessor;
at least one button operable by a user to store a measured distance in association with specific reference points between which the measured distance was measured.

18. The duct geometry measurement tool of claim 17, further comprising:
microprocessor-executable instructions stored in said memory to calculate a distance between said first and second reference points as a function of the first predetermined spatial relationship, the second predetermined spatial relationship, and a distance measurement taken between the flag and the handheld unit by the distance measuring unit.

19. The duct geometry measurement tool of claim 14, wherein said tool is configured to provide an angular measurement relating said first reference point to said second reference point, and wherein said memory is configured to store said angular measurement in association with a corresponding distance measurement.

20. A method for measuring geometry for a customized ductwork segment having geometry for joining specific first and second ducts, the method comprising:
measuring a respective distance between each of a plurality of pairs of reference points of said ducts, each pair of reference points comprising a first reference point on said first duct and a second reference point on said second duct;
storing each measured distance in a memory of a computerized device; and
transmitting data corresponding to said stored distance measurements via a communications port of said computerized device.

21. The method of claim 20, wherein each reference point comprises a corner of a respective duct having a substantially rectangular cross-section.

22. The method of claim 20, further comprising:
mounting a distance measuring unit on said first duct in a first predetermined spatial relationship to first second reference point of said first duct;
mounting a flag on said second duct in a second predetermined spatial relationship to said second reference point of said second duct; and
storing each respective distance measurement in a memory of a computerized tool in association with respective reference points of said first and second ducts between which each distance was measured;
wherein measuring each distance comprises:
operating said distance measuring unit to obtain a distance measurement between said flag and said distance measuring unit; and
calculating said distance between said reference points as a function of the first predetermined spatial relationship, the second predetermined spatial relationship, and a distance measurement taken between the flag and the handheld unit by the distance measuring unit.
